(19) United States
(12) Patent Application Publication
(10) Pub. No.: US 2003/0055515 A1
(43) Pub. Date: Mar. 20, 2003

(54) Header for signal file temporal synchronization

(76) Inventors: Ahmad Masri, Nahis Village (IL); Lior Fite, D.N. Misgav (IL)

Correspondence Address: KAPLAN & GILMAN , L.L.P., 900NROUTE 9 NORTH, WOODBRIDGE, NJ, 07095, US

(21) Appl. No.: 09/957,118

(22) Filed: Sep. 20, 2001

(51) Int. Cl. G06F 17/00

(52) U.S. Cl. 700/94

(57) ABSTRACT

A method of synchronizing two voice files is described. A header is added to a test sound file and the augmented file digitized, encoded and transmitted via a packet switched data network. The header comprises a tone which varies by increasing from a very low amplitude to a precisely detectable peak value, and then decreasing to a very low amplitude again. The voice data in the file follows the peak amplitude by a known delay. The header peak value is precisely located in time by searching for the peak amplitude. Adding the known delay precisely locates, temporally, the beginning of the voice data. This method allows the synchronization of the original file with its transmitted version to a very high precision.

### TECHNICAL FIELD

This invention relates to the synchronization of signal files. More particularly, it relates to a method of processing sound files to facilitate the synchronization of an original sound file and a copy of it after transmission over a data network in a telephonic application.

### BACKGROUND OF THE INVENTION

With reference to FIG. 1 a typical implementation of Internet telephony is depicted. The telephone calls are typically implemented between gateways that communicate over the Internet. Each of the gateways is then connected to an end user telephone via a conventional telephone network such as the public switched telephone network (“PSTN”), for example. With reference to FIG. 1, there is shown an originating telephone 100 connected to an Internet telephony gateway 102 via the PSTN 101. The Internet telephony gateway 102 is connected via the Internet 110 to a second Internet telephony gateway 103. The second Internet telephony gateway 102 is connected to a second PSTN 104 on the receiving side of the communications path, and the receiving side PSTN 104 is connected to the receiving telephone 105. While in the Internet 110 the audio signals comprising the telephone call are transmitted as packets using the Internet Protocol (“IP”) or some other well-known packet switching technique.

When testing the quality of an Internet telephone call, a telephone call is first made and a prerecorded voice message is played from an originator of the call to a receiver of the call. The receiver of the call records the received voice message. The recorded file is then compared against the original file. The differences between the two are an indication of the voice quality.

In order to compare the two sound files they should be synchronized so that the comparison begins at the same approximate starting point in the sound clip. If this is not done, the results may generate false negatives. In other words, what may be measured as latency or delay between the recorded call and the originating call may actually be attributed to improper synchronization of the two files prior to testing. Objective speech quality measurement may thus be dependent upon proper synchronization of the two files.

Conventional techniques for the temporal comparison of two files, however, may be unsatisfactory for a number of reasons. For example, one technique manually performs synchronization. A test engineer would take the two sound clips, and using visual displays of the amplitude signal versus time, visually aligns the two plots so that the comparison begins at the same point in the sound clip. This method, relying on human visual acuity and subjectivity, may generate a bad score for sound fidelity when in actuality the problem may not be the fidelity of the transmitted file to the original, but rather the inability of the test engineer to accurately synchronize the files.

In another example, quite analogous to the use of a start bit sequence in digital files, a tone of a precise amplitude is appended as a header to a test sound file. Once the header is detected, the actual audio signal begins immediately afterwards. One problem with such a method is that depending on the varying characteristics of Voice Over Internet Protocol (“VOIP”) telephony, including echo cancellation, voice active detection, and the inherent differences among codes and switches, a small but significant amount, i.e. 30 to 40 milliseconds, of the signal can be cut. This makes it difficult to synchronize the original sound file with its transmitted version, and often generates false negative results. Such a situation is depicted in FIGS. 2A and 2B. FIG. 2A depicts an original sound clip with an amplitude tone appended as a header. FIG. 2B depicts the transmitted version of this file, with some of the signal clipped in transmission. The two files may not be synchronized reliably. Although the constant amplitude header tone, the signal portion, and the gap between them are discernable, some of the signal has been cut.

What is therefore needed is a method to precisely synchronize an original audio file with a transmitted version of that file over a communications link to improve speech quality measurement.

### BRIEF DESCRIPTION OF THE DRAWINGS:

FIG. 1 is a block diagram of a system suitable for use with one embodiment of the invention;

FIG. 2A depicts an original sound file with a fixed tone header;

FIG. 2B depicts the recorded transmitted version of the audio signal depicted in FIG. 2A;

FIG. 3 is a block diagram of an exemplary system level implementation of the present invention; and

FIG. 4 is a plot of a random audio signal file in accordance with one embodiment of the invention.

### DETAILED DESCRIPTION OF THE INVENTION

The embodiments of the invention address the problems associated with existing systems by providing a method for synchronizing two sound files, one of which has been transmitted over a data network. The method operates by attaching a header tone with a precisely determinable midpoint to a signal file, said signal file originating from a source, either directly or through intermediate devices. There is additionally a known delay from the midpoint of the header tone to the beginning of the data portion of the signal file. Generally the signal file may be a sound file comprising human voice communications data. However, other types of sound data are intended to be included in the method of the present invention. These other types of sound data may include music, synthesized speech, recording of sounds found in the natural and artificial environments, and the like.

In one embodiment of the present invention synchronization is facilitated by the header tone midpoint and the known delay is unaffected by, or invariant over, the various processing operations performed on the sound file such as digitization, coding, transmission, decoding, and playback. To appreciate how and why this processing is done, some understanding of sound file transmission of data networks, such as in Internet telephony, may be helpful.

Modern data networks, such as the Internet, utilize packet switching. In packet switching there is no guaranteed or dedicated communications path between the source and the destination all of the time. Small blocks of data, or packets, are transmitted over the route established by the network as the best available path for that packet at that time. This characteristic optimizes the use of available bandwidth, which is the amount of data that can be passed along a communications channel in a given period of time.

Therefore, modern packet switched data networks can be used to transmit voice information, such as telephone calls, with relatively efficient use of the available bandwidth as compared to other networks, such as circuit-switched networks. If a path is not immediately available, the packet network simply delays the packet until a path becomes available. This variable delay is known as latency.

The improved efficiency of packet switched data networks, however, is only useful if the above described latency is small enough not to affect human conversation. Humans can generally withstand latencies up to 250 milliseconds. With more delays, however, conversation is perceived as being of low quality.

Additionally, there are other factors which affect the perceptible quality of a voice telephone call sent over packet switched data networks. Among these are the various coding schemes used to encode the voice conversation.

When telephones were switched by means of analog switches there was literally a wire path which carried the conversation in each direction. The full analog signal was sent on the wires, and it was this analog signal that drove the speaker in the earpiece at each end. As digital switching was introduced the analog signal representing voice information needed to be represented as a sequence of 1's and 0's. This gave rise to what is now known as voice coding.

Standard telephony uses a method defined by ITU recommendation G.711, which is available from the International Telecommunications Unit, Geneva. The G.711 standard defines recommended characteristics for encoding voice-frequency signals.

Under the G.711 standard, samples are encoded using Pulse Code Modulation (“PCM”), which is the most predominant type of digital modulation currently in use. Under this standard, voice is sampled at a frequency of 8 kilohertz (“KHz”), using eight bit samples.

In actuality, twelve or more bits are required to achieve an acceptable dynamic range of volume. However, using the fact that the human ear responds to volume changes on a logarithmic, as opposed to linear scale, further coding known as companding allows overall acceptable quality, or what is known as “Toll Quality” in telephony, with just eight bits.

There are two companding methods generally in use known as the μ-law, which is used in the United States, and the A-law, which is used in most other countries. The μ-law is a type of non-linear (logarithmic) quantizing, companding and encoding technique for speech signals based on the μ-law. Quantizing refers to the process of assigning values to waveform samples, such as analog signals, by comparing those samples to discrete steps. The μ-law type of companding uses a μ factor of 255 and is optimized to provide a good signal-to-quantizing noise ratio over a wide dynamic range.

The A-law type of compandor is used internationally and has a similar response as the μ-law compandor, except that it is optimized to provide a more nearly constant signal-to-quantizing noise ratio at the cost of some dynamic range.

The G.711 standard recommends both the μ-law and A-law encoding laws. The standard generates a voice stream of 64 kilo-bits-per-second (“kbps”). Voice signals whose spectrum contains frequencies of 4 KHz or less are handled with acceptable quality.

In order to decrease the required bandwidth from the 64 kbps used in the G.711 standard, telephony engineers have devised various alternative coding schemes which are specially adapted to the coding of human speech. These coding schemes are sometimes referred to as “VoCoders” for voice coders. The use of these additional coding schemes lowered the bandwidth required for voice telephone communications. In the areas of voice telephone communications sent over packet switched data networks, ITU standard G.723.1 has been recommended. The G.723.1 standard is available from the International Telecommunications Unit, Geneva. It specifies a coder that can be used for compressing speech at a very low bit rate.

This standard, although highly complex and requiring significant computing power to encode, offers good quality voice communication over the Internet at either 6.3 or 5.3 kbps. This evidences a significant reduction in required bandwidth and the ability to transmit numerous telephone calls through a network.

According to one embodiment of the present invention, the header tone appended to the beginning of a sound file comprises a tone of fixed frequency beginning at a low, near zero, or zero amplitude, gradually increasing in amplitude, but not in frequency, to a peak amplitude value and then decreasing in amplitude to zero or near zero. From the peak amplitude point of the header tone to the beginning of the data of the sound file is a predetermined delay. This type of header appended to a sound file will allow for the synchronization in time of just such a sound file with a copy of the same sound file received on the other end of a packet switched network through a telephony gateway. Importantly, it will preserve its synchronization properties during digitization, encoding, transmission through a communications network, reception, decoding and reconversion to analog format.

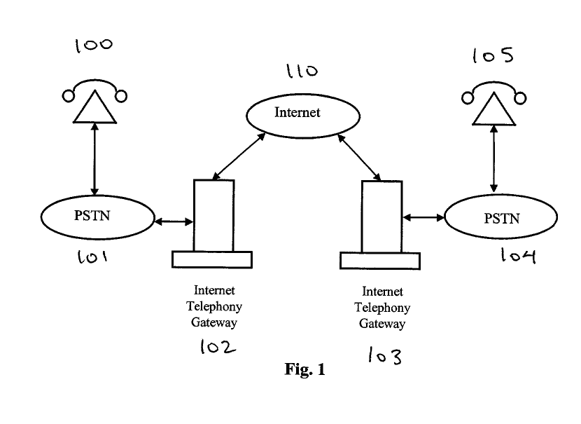

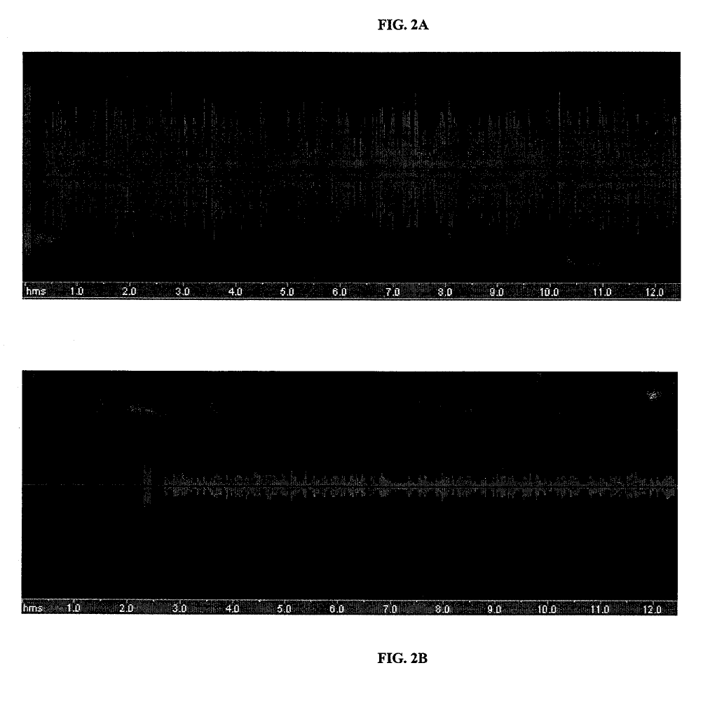

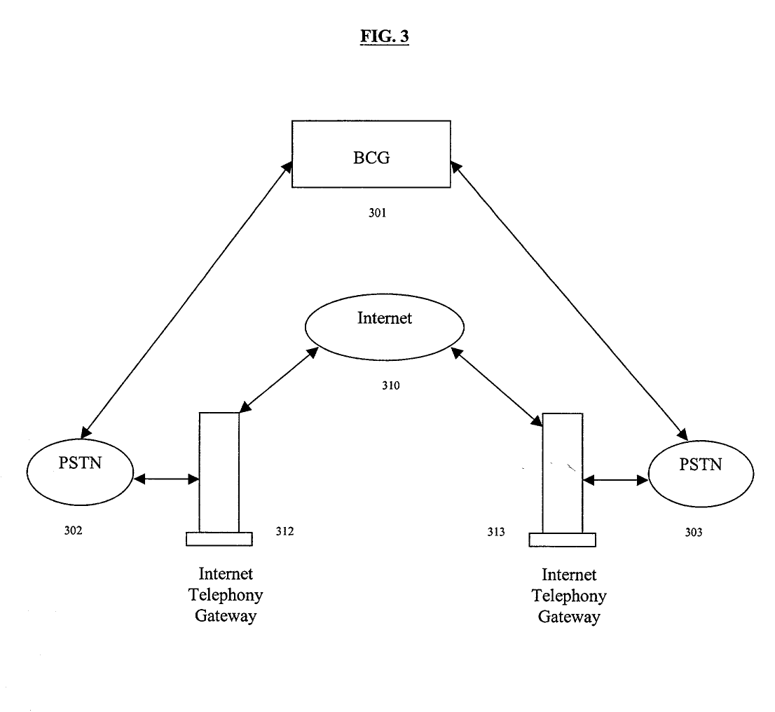

With reference to FIG. 3 a system level implementation of an embodiment of the present invention is depicted. FIG. 3 represents a similar system architecture as does FIG. 1, with at least one difference. The two telephones each connecting to a PSTN in FIG. 1 are now replaced by a Bulk Call Generator (“BCG”) 301. The BCG may create a load on the system and simulate numerous users making telephone calls into the system. A BCG can further integrate any voice quality measurement algorithms, such as those described above. The BCG 301 generates calls which are sent through the PSTN 302 and 303. Alternatively, the two PSTNs 302 and 303 could be coalesced into the same PSTN, where the BCG simply uses different telephone numbers to create different interfaces with the same PSTN. In other possible embodiments the BCG can be dispensed with, and test calls can be made and recorded for later comparison using an architecture similar to that depicted in FIG. 1.

Continuing with reference to FIG. 3, the Bulk Call Generator 301 originates a call through one PSTN 302. That call is interfaced to the Internet via the Internet telephony gateway 312 and converted to data packets. The data packets are, as described above, sent over the Internet using an applicable Internet protocol for sending voice data, such as VoIP. Other protocols may be appropriate as well. Once packetized, the voice data is sent over the Internet 310, or some other data network, and ultimately received at a different interface, in this case another Internet telephony gateway 313, which converts the voice data to a format in which it can be sent over the PSTN 303. On the receiving end, the received call can be transmitted to the BCG 301. The BCG 301 now has two versions of the same call: (1) the original voice call that it sent which has been stored as a sound file, and (2) the received version of the same call which has been encoded by the VoCoder on one end, packetized, sent over the Internet, decoded on the other end and stored as a sound file.

The BCG 301 then acts as a test device, essentially a processor, which can implement the user chosen voice quality measurement algorithm. The voice quality measurement algorithm takes as its operands the two voice files and performs a quality comparison according to the specifications in the particular voice quality objective measurement chosen.

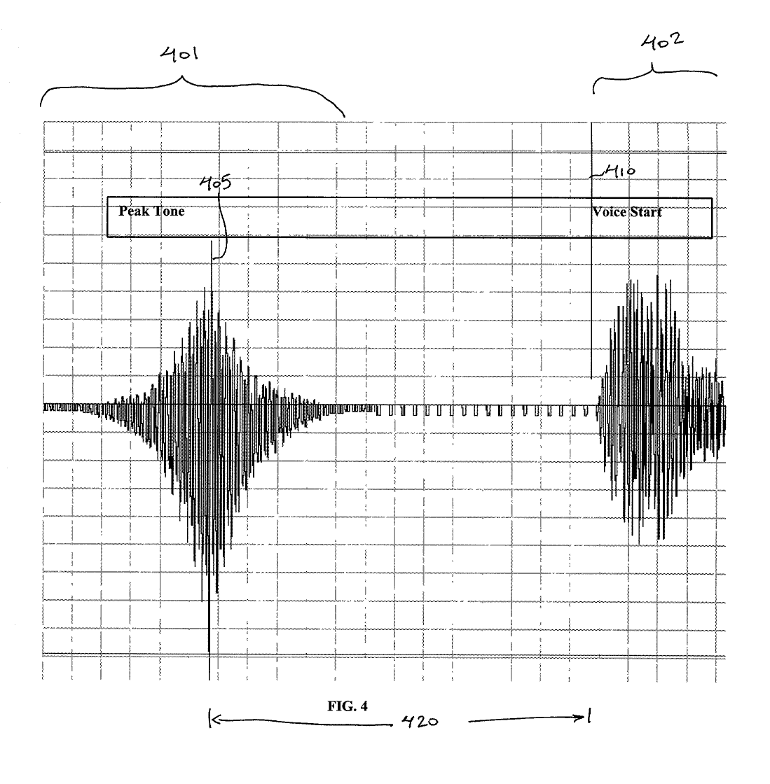

However, in order to properly implement the voice quality measurement the two files should be synchronized. This is one area where the method of the present invention comes into play as will be next described with reference to FIG. 4.

FIG. 4 is a plot of a sound signal from a sound file such as a voice telephone call. The sound file is plotted showing amplitude versus time, where the independent variable time is plotted along the horizontal axis and the dependant variable amplitude is plotted along the vertical axis. The sound file comprises a header 401, and sound data 402. There is a gap between the end of the header and the beginning of the sound data. The header tone varies in amplitude and has a distinctly and precisely detectable maximum value 405. Between the point in time where the maximum amplitude value of the header tone 405 occurs and the actual beginning of the voice data 410 occurs, there is a fixed, known delay 420. The length, in time, of the fixed delay can be set by the user, and can obviously vary at will among any set of reasonable values. In one embodiment of the present invention the delay should be at least long enough so that the precise intermediate point of the header tone can be located when measured in variable time, prior to the beginning of the voice data. In this manner the processor implementing the voice quality measurement will be able to locate the precise intermediate point and begin timing the elapsed time to implement the synchronization prior to the time that the processor initiates comparing the sound data in the two files.

Unlike the problems inherent in the conventional systems, this method can be implemented on a computer or other processor based device, and thus obviates any manual attempts at synchronization. The entire process of appending the header to a signal file, transmission of the augmented signal, and signal comparison can be implemented on a computer or other processor based device with the appropriately written software. The header is appended to the signal file by any of the means commonly now known or to be known. Such means may utilize, for example, sound file processing software (such as waveguides, etc.) or the like.

Additionally, even if some of the header tone or the data portion of the signal is clipped, proper synchronization is not affected. The key temporal markers are the precisely detectable midpoint of the header tone, and the fixed delay following it. The loss of some of the low amplitude portion of the header signal prior or subsequent in time to the peak amplitude maximum will not affect the precise temporal location of the header intermediate point.

Similarly, the loss of some of the data portion of the signal will not affect the beginning point for synchronized comparison, i.e., the point in time determined by adding the known delay to the header intermediate point. Thus the synchronization method of the present invention is invariant over the signal processing operations commonly done in transmission of sound files over data networks. These signal processing operations do not affect the key temporal markers necessary for highly precise synchronization.

In other embodiments of the invention, the files to be synchronized can be any generic signal files. It is not intended to restrict the invention to sound files; rather, any signal varying as a function of time, such as that generated by video devices, transducers of any type, data acquisition devices, recordings of any type, or the like, can be synchronized with any other similar file using techniques described herein. Synchronization need not be only with a transmitted copy of the original file. The invention has much utility for the generic synchronization of any two signal files where a signal amplitude varies with time so as to facilitate a variety of processing and comparison operations.

Similarly, the header segment of the file used to implement the present invention may be any general signal having a time varying amplitude, generated in a variety of ways, either natural or artificial, besides the generation of sound. The intermediate point of the header need only be precisely detectable, and may not necessarily be restricted to a maximum in signal amplitude. Numerous alternative signal signatures are possible for the intermediate point, such as a minimum between two maxima, a point at a maximum or minimum in frequency, or the like.

The foregoing description of the embodiments of this invention has been presented for purposes of illustration and description. It is not intended to be exhaustive or to limit the embodiments of the invention to the form disclosed, and, obviously, many modifications and variations are possible. Such modifications and variations that may be apparent to a person skilled in the art are intended to be included within the scope of this invention as defined by the accompanying claims.

What is claimed:

1. A method comprising:
receiving a signal file;
attaching a header to the signal file, said header comprising:
a header signal with a precisely detectable intermediate point; and
a known delay between the intermediate point and the beginning of the signal file.

2. The method of claim 1, where the intermediate point retains the property of being precisely detectable after at least each of the following operations on the signal file: conversion from analog to digital format, encoding, transmission through a communications network, decoding, and reconversion to analog format.

3. The method of claim 2 where the signal file is a sound file.

4. The method of claim 3 where the sound file is a voice file.

5. The method of claim 4 where the header signal comprises a tone that begins at zero or near zero amplitude, increases in amplitude to a peak value, and then decreases in amplitude to zero or near zero.

6. The method of claim 5, where the tone parabolically increases to, and decreases from, the peak value.

7. The method of claim 1, where the header signal comprises an amplitude signal that begins at or near zero amplitude, parabolically increases to, and then decreases from, the intermediate point, and where the intermediate point has a maximum amplitude.

8. The method of claim 1, where the header signal comprises an amplitude signal and the intermediate point comprises one of an amplitude minimum between two amplitude maxima or an amplitude maximum between two amplitude minima.

9. A method comprising:
receiving a signal file;
attaching to the signal file a header, said header comprising:
a header signal with a precisely detectable intermediate point; and
a known delay between the intermediate point and the beginning of the signal;
converting the augmented signal file to digital format;
transmitting the signal file;
recording the transmitted file; and
synchronizing the recorded file with the original file by detecting the intermediate point of the header of each file.

10. The method of claim 9, where the intermediate point retains the property of being precisely detectable after at least each of the following operations on the signal file: conversion from analog to digital format, encoding, transmission through a communications network, decoding, and reconversion to analog format.

11. The method of claim 10 where the signal file is a sound file.

12. The method of claim 11 where the sound file is a voice file.

13. The method of claim 12 where the header signal comprises a tone that begins at zero or near zero amplitude, increases in amplitude to a peak value, and then decreases in amplitude to zero or near zero.

14. The method of claim 13, where the tone parabolically increases to, and decreases from, the peak value.

15. The method of claim 10, where the header signal comprises an amplitude signal and the intermediate point comprises at least one of: an amplitude minimum between two amplitude maxima or an amplitude maximum between two amplitude minima.

16. The method of claim 15, where the amplitude signal varies parabolically to and from the intermediate point.

17. An apparatus for synchronizing signal files comprising:
an augmenter to attach a header to a signal file, said header comprising:
a header signal with a precisely detectable intermediate point; and
a known delay between the intermediate point and the beginning of the signal.

18. The apparatus of claim 17, further comprising:
a converter to convert the signal file to digital format;
a transmitter to transmit the digitized file;
a recorder to record the transmitted file; and
a detector to detect the intermediate point of the header.

19. The apparatus of claim 18, further comprising:
an encoder to encode the digitized file prior to transmission; and
a decoder to decode the transmitted file.

20. The apparatus of claim 19, where the precisely detectable intermediate point retains the property of being precisely detectable after at least each of the following processes: conversion to digital format, encoding, transmission through a communications network, decoding, and reconversion to analog format.

21. The apparatus of claim 20, where:
the header signal comprises an amplitude signal; and
the intermediate point comprises at least one of: an amplitude minimum between two amplitude maxima or an amplitude maximum between two amplitude minima.

22. The apparatus of claim 20 where the header signal comprises a tone that begins at zero or near zero amplitude, increases in amplitude to a peak value, and then decreases in amplitude to zero or near zero.

23. An article comprising a computer readable medium having instructions stored thereon which when executed causes:
a header signal to be attached to a signal file, the header signal having
a precisely detectable intermediate point; and
a known delay between the intermediate point and the beginning of the signal file.

24. An article comprising a computer readable medium having instructions stored thereon which when executed causes:
attaching to a signal file a header comprising:
a header signal with a precisely detectable intermediate point; and
a known delay between the intermediate point and the beginning of the data signal;
converting the signal file to digital format;
transmitting the signal file;
receiving the signal file;
converting the signal file to analog format;
recording the received file; and
synchronizing the recorded file with the transmitted file by detecting the intermediate point of each file's header.

25. The article of claim 24, having further instructions stored thereon which when executed cause:
after the first converting, encoding the digital file; and
after the receiving, decoding the digital file.

26. The article of claim 23 where the signal with a precisely detectable intermediate point retains the property of being precisely detectable after at least each of the following processes: conversion to digital format, encoding, transmission through a communications network, decoding, and reconversion to analog format.

27. The article of claim 26, where:
the header signal comprises an amplitude signal; and
the intermediate point comprises at least one of: an amplitude minimum between two amplitude maxima or an amplitude maximum between two amplitude minima.

28. The article of claim 26, where the header signal comprises a tone that begins at zero or near zero amplitude, increases in amplitude to a peak value, and then decreases in amplitude to zero or near zero.
